(19) United States
(12) Patent Application Publication
(10) Pub. No.: US 2009/0196325 A1
(43) Pub. Date: Aug. 6, 2009

(54) PERFORMANCE TESTING APPARATUS FOR HEAT PIPES

(75) Inventor: TAY-JIAN LIU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXCONN TECHNOLOGY CO., LTD., Tu-Cheng (TW)

(21) Appl. No.: 12/185,120

(22) Filed: Aug. 4, 2008

(30) Foreign Application Priority Data
Feb. 1, 2008 (CN) 200810066031.1

(51) Int. Cl. G01K 13/00

(52) U.S. Cl. 374/147

(57) ABSTRACT

A performance testing apparatus for a heat pipe includes a heating set, a cooling set, and a supporting set adjustably supporting the heating set and the cooling set. The heating set includes a first immovable portion and a first movable portion. A heating channel is defined between the first immovable portion and the first movable portion. Temperature sensors are attached to the first immovable portion and the first movable portion. The cooling set includes a second immovable portion and a second movable portion. A cooling channel is defined between the second immovable portion and the second movable portion. Temperature sensors are attached to the second immovable portion and the second movable portion. The supporting set includes first, second supporting seats supporting the heating set and the cooling set thereon. Orientations of the first and second supporting seats are changeable.

### BACKGROUND OF THE INVENTION

1. Field of the Invention

The present invention relates generally to testing apparatuses, and more particularly to a performance testing apparatus for heat pipes.

2. Description of related art

It is well known that a heat pipe is generally a vacuum-sealed pipe. A porous wick structure is provided on an inner face of the pipe, and phase changeable working media employed to carry heat is included in the pipe. Generally, according to where the heat is input or output, a heat pipe has three sections, an evaporating section, a condensing section and an adiabatic section between the evaporating section and the condensing section.

In use, the heat pipe transfers heat from one place to another place mainly by exchanging heat through phase change of the working media. Generally, the working media is a liquid such as alcohol or water and so on. When the working media in the evaporating section of the heat pipe is heated up, it evaporates, and a pressure difference is thus produced between the evaporating section and the condensing section in the heat pipe. The resultant vapor with high enthalpy rushes to the condensing section and condenses there. Then the condensed liquid reflows to the evaporating section along the wick structure. This evaporating/condensing cycle continually transfers heat from the evaporating section to the condensing section. Due to the continual phase change of the working media, the evaporating section is kept at or near the same temperature as the condensing section of the heat pipe. Heat pipes are used widely owing to their great heat-transfer capability.

In order to ensure the effective working of the heat pipe, the heat pipe generally requires testing before being used. The maximum heat transfer capacity (Qmax) and the temperature difference (ΔT) between the evaporating section and the condensing section are two important parameters in evaluating performance of the heat pipe. When a predetermined quantity of heat is input into the heat pipe through the evaporating section thereof, thermal resistance (Rth) of the heat pipe can be obtained from ΔT, and the performance of the heat pipe can be evaluated. The relationship between these parameters Qmax, Rth and ΔT is Rth=ΔT/Qmax. When the input quantity of heat exceeds the maximum heat transfer capacity (Qmax), the heat cannot be timely transferred from the evaporating section to the condensing section, and the temperature of the evaporating section increases rapidly.

A typical method for testing the performance of a heat pipe is to first insert the evaporating section of the heat pipe into a liquid at constant temperature; after a period of time the temperature of the heat pipe will become stable, then a temperature sensor such as a thermocouple, a resistance thermometer detector (RTD) or the like can be used to measure ΔT between the liquid and the condensing section of the heat pipe to evaluate the performance of the heat pipe. However, Rth and Qmax can not be obtained by this test, and the performance of the heat pipe can not be reflected exactly by this test.

Referring to FIG. 11, a related performance testing apparatus for heat pipes is shown. The apparatus has a resistance wire 1 coiling round an evaporating section 2a of a heat pipe 2, and a water cooling sleeve 3 functioning as a heat sink and enclosing a condensing section 2b of the heat pipe 2. In use, electrical power controlled by a voltmeter and an ammeter flows through the resistance wire 1, whereby the resistance wire 1 heats the evaporating section 2a of the heat pipe 2. At the same time, by controlling flow rate and temperature of cooling liquid entering the cooling sleeve 3, the heat input at the evaporating section 2a can be removed from the heat pipe 2 by the cooling liquid at the condensing section 2b, whereby a stable operating temperature of adiabatic section 2c of the heat pipe 2 is obtained. Therefore, Qmax of the heat pipe 2 and ΔT between the evaporating section 2a and the condensing section 2b can be obtained by temperature sensors 4 at different positions on the heat pipe 2.

However, in the test, the related testing apparatus has the following drawbacks: a) it is difficult to accurately determine lengths of the evaporating section 2a and the condensing section 2b which are important factors in determining the performance of the heat pipe 2; b) heat transference and temperature measurement may easily be affected by environmental conditions; and, c) it is difficult to achieve sufficiently intimate contact between the heat pipe and the heat source and between the heat pipe and the heat sink, which results in uneven performance test results of the heat pipe. Furthermore, due to awkward and laborious assembly and disassembly in the test, the testing apparatus can be only used in the laboratory, and can not be used in the mass production of heat pipes.

In mass production of heat pipes, a large number of performance tests are needed, and the apparatus is used frequently over a long period of time; therefore, the apparatus not only requires good testing accuracy, but also requires easy and accurate assembly to the heat pipes to be tested. The testing apparatus affects the yield and cost of the heat pipes directly; therefore, testing accuracy, facility, speed, consistency, reproducibility and reliability need to be considered when choosing the testing apparatus. Therefore, the testing apparatus needs to be improved in order to meet the demand for mass production of heat pipes.

What is needed, therefore, is a performance testing apparatus for heat pipes suitable for use in mass production of heat pipes.

### SUMMARY OF THE INVENTION

A performance testing apparatus for heat pipes in accordance with a first embodiment of the present invention comprises a heating set for heating evaporating sections of the heat pipes, a cooling set for cooling condensing sections of the heat pipes, and a supporting set adjustably supporting the heating set and the cooling set thereon. The heating set comprises a first immovable portion and a first movable portion being movable relative to the first immovable portion. Two heating channels are defined between the first immovable portion and the first movable portion for receiving the evaporating sections of the heat pipes, respectively. A temperature sensor is exposed to each of the heating channels for detecting temperature of the evaporating sections of the heat pipes. A heating member is attached to at least one of the first movable portion and the immovable portion. The cooling set comprises a second immovable portion and a second movable portion being movable relative to the second immovable portion. Two cooling channels are defined between the second immovable portion and the second movable portion for receiving the condensing sections of the heat pipes. A temperature sensor is exposed to each of the two cooling channels for detecting temperature of the condensing sections of the heat pipes. A cooling passageway is formed in the second immovable portion. The supporting set comprises a first supporting seat supporting the heating set thereon and a second supporting seat supporting the cooling set thereon. An orientation of the first supporting seat is adjustable relative to the second supporting seat whereby an orientation of the heating set relative to the cooling set is adjustable to meet a bent angle between the evaporation section and the condensation section of the heat pipe in test.

### BRIEF DESCRIPTION OF THE DRAWINGS

Many aspects of the present performance testing apparatus for heat pipes can be better understood with reference to the following drawings. The components in the drawings are not necessarily drawn to scale, the emphasis instead being placed upon clearly illustrating the principles of the present performance testing apparatus for heat pipes. Moreover, in the drawings, like reference numerals designate corresponding parts throughout the several views.

FIG. 1 is an assembled view of a performance testing apparatus for heat pipes in accordance with a first embodiment of the present invention.

FIG. 2 is an exploded, isometric view of the performance testing apparatus for heat pipes of FIG. 1.

FIG. 3 shows a first supporting seat of the performance testing apparatus for heat pipes of FIG. 2.

FIG. 4 shows a second supporting seat of the performance testing apparatus for heat pipes of FIG. 2.

FIG. 5 is an assembled view of a performance testing apparatus for heat pipes in accordance with a second embodiment of the present invention.

FIG. 6 shows a first supporting seat of the performance testing apparatus for heat pipes of FIG. 5.

FIG. 7 shows a second supporting seat of the performance testing apparatus for heat pipes of FIG. 5.

FIG. 8 is an assembled view of a performance testing apparatus for heat pipes in accordance with a third embodiment of the present invention.

FIG. 9 is an exploded view of a supporting seat of the performance testing apparatus for heat pipes of FIG. 8.

FIG. 10 shows a top portion of the supporting seat of FIG. 9 from a bottom aspect.

FIG. 11 is a performance testing apparatus for heat pipes in accordance with related art.

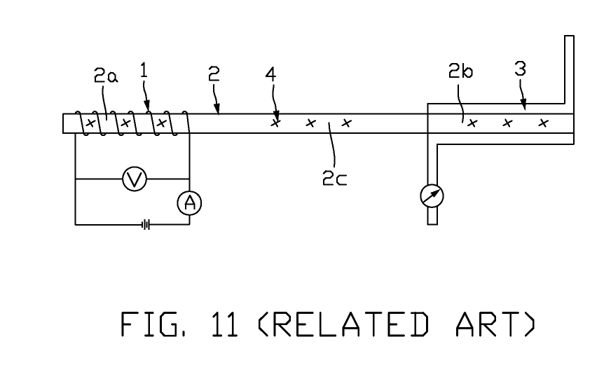

### DETAILED DESCRIPTION OF THE INVENTION

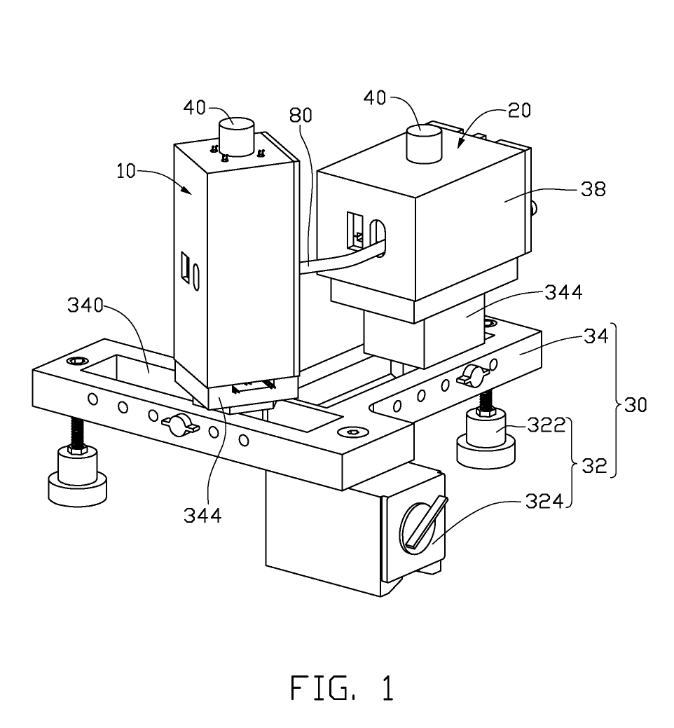

Referring to FIG. 1, a performance testing apparatus for heat pipes of a first embodiment of the present invention is shown. The testing apparatus comprises a heating set 10 for heating evaporating sections of a heat pipe 80 and another heat pipe (not shown), a cooling set 20 for cooling condensing sections of the heat pipe 80 and the another heat pipe, and a supporting set 30 supporting the heating set 10 and the cooling set 20 thereon.

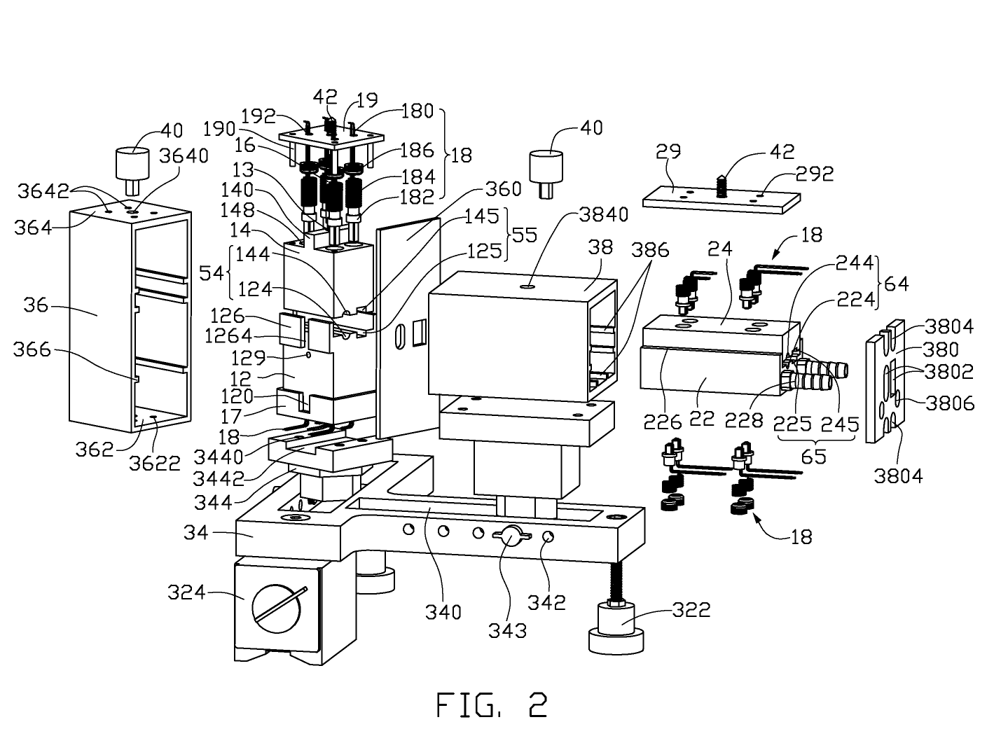

Referring also to FIG. 2, the heating set 10 comprises a first immovable portion 12 and a first movable portion 14 positioned on the first immovable portion 12. The first movable portion 14 is movable relative to the first immovable portion 12.

The first immovable portion 12 is made of material having good heat conductivity. A first heating member (not shown) such as an immersion heater, resistance coil, quartz tube and Positive temperature coefficient (PTC) material or the like is embedded in the first immovable portion 12. The first immovable portion 12 has a central portion thereof extending a first extension 120 downwardly. The first immovable portion 12 defines a hole (not shown) in the first extension 120. The first heating member is accommodated in and thermally contacts an inner face of the hole of the first immovable portion 12. Two spaced wires (not shown) extend beyond the first extension 120 from a bottom end of the first heating member for connecting with a power supply (not shown). The first immovable portion 12 has a first heating groove 124 and a second heating groove 125 defined in a top face thereof, for receiving evaporating sections of the heat pipe 80 and the another heat pipe to be tested therein. The first heating groove 124 is spaced from and parallels to the second heating groove 125. In this embodiment, the first heating groove 124 has a semicircular cross section. The second heating groove 125 has a rectangular cross section. Each of the first, second heating grooves 124, 125 has two through holes (not shown) in communication therewith. Each through hole extends through the first immovable portion 12 from the top face to a bottom face thereof. A first temperature sensor 18 is accommodated in each of the through holes and has a detecting section (not labeled) thereof exposed to a corresponding one of the first, second heating grooves 124, 125. In this embodiment, the first heating member is perpendicular to the first, second heating grooves 124, 125.

The first movable portion 14 is also made of material having good heat conductivity. The first movable portion 14 has an extension 140 extending upwardly from a middle of a top face thereof. The first movable portion 14 defines a hole 13 in the extension 140. A second heating member 16 is accommodated in the hole 13 of the first movable portion 14. Two spaced wires (not labeled) extend from a top end of the second heating member 16 beyond the extension 140 for connecting with the power supply. The first movable portion 14, corresponding to the first, second heating grooves 124, 125 of the first immovable portion 12, has a third, fourth heating grooves 144, 145 defined in a bottom face thereof. A first heating channel 54 is cooperatively defined by the first, third heating grooves 124, 144, a second heating channel 55 is cooperatively defined by the second, fourth grooves 125, 145, when the first movable portion 14 moves to the first immovable portion 12. The first heating channel 54 has a circular cross section. The second heating channel 55 has a rectangular cross section. When the first movable portion 14 moves to the first immovable portion 12, an intimate contact between the evaporating sections of the heat pipes and the first movable, immovable portions 14, 12 can be realized, thereby reducing heat resistance between the evaporating sections of the heat pipes and the first movable, immovable portions 14, 12. The first movable portion 14 has two through holes 148 defined at each side of the extension 140 to accommodate two first temperature sensors 18 therein. The through holes 148 each are in communication with a corresponding one of the third, fourth heating grooves 144, 145. Each first temperature sensor 18 comprises a positioning socket 182 fitted in the hole 148 and a pair of thermocouple wires 180 fitted in the socket 182. A spring coil 184 surrounds the wires 180 and the socket 182. The spring coil 184 is compressed by a screw 186 engaging in the hole 148 of the first movable portion 14. Each of the thermocouple wires 180 has a detecting section (not labeled) thereof located in the corresponding one of the third, fourth heating grooves 144, 145. The detecting sections are capable of automatically contacting the evaporating sections of the heat pipes to detect the temperature of the evaporating sections. In this embodiment, the second heating member 16 is perpendicular to the third, fourth heating grooves 144, 145.

In this embodiment, the first immovable portion 12 has two flanges 126 integrally extending upwardly and toward the first movable portion 14 from two opposite outer sides of an upper portion thereof. An outer face of each flange 126 extends outwardly beyond a corresponding outer face of a main body (not labeled) of the first immovable portion 12. The two flanges 126 function as a positioning structure to position the first movable portion 14 therebetween, thereby preventing the first movable portion 14 from deviating from the first immovable portion 12 during test of the heat pipes in mass production. The two flanges 126 ensure that the two pairs grooves 124, 144 and 125, 145 of the first immovable, movable portions 12, 14 to always be aligned with each other. Thus, the heating channels 54, 55 can be always precisely and easily formed for receiving the evaporating sections of the heat pipes for test. The first movable portion 14 slidably contacts the two flanges 126 of the first immovable portion 12 when it moves relative to the first immovable portion 12. Alternatively, the first movable portion 14 can have two flanges slidably engaging two opposite sides of the first immovable portion 12 to keep the first immovable portion 12 aligned with the first movable portion 14. In this embodiment, the first immovable portion 12 defines a bore 129 below one of the flanges 126 in a side face thereof for receiving a second temperature sensor therein to detect a temperature of the first heating member 16 and the first immovable portion 12, when the first movable portion 14 moves away from the first immovable portion 12. The flange 126 corresponding to the bore 129 defines a through slot 1264 for allowing wires of the second temperature sensor to extend therethrough and upwardly.

In order to construct a thermally steady environment for testing the heat pipes 80, the heating set 10 is enclosed in a first enclosure 36. The first enclosure 36 has a substantially cubical figure and has a bottom 362 positioned on the supporting set 30 and three interconnecting sidewalls (not labeled) extending upwardly from the bottom 362. An entrance (not labeled) is defined in an opened side of the first enclosure 36 for disposing, assembling or dismantling the first movable portion 14 and the movable portion 12 in the first enclosure 36. A door board 360 is removably attached to the entrance for facilitating the first immovable portion 12 and the first movable portion 14 entering into/exiting out of the first enclosure 36. Two opposite ones of the sidewalls form a plurality of ribs 366 on inner faces thereof, for reducing contacting area between the heating set 10 and the first enclosure 36. Corresponding to the channels 54, 55 between the first immovable portion 12 and the first movable portion 14, two openings (not labeled) are defined in each of the door board 360 and the sidewall of the first enclosure 36 facing the door board 360. A ceiling 364 of the first enclosure 36 defines two pairs of spaced through bores 3642 to allow wires of the second heating member 16, the first temperature sensors 18 in the first movable portion 14 extending therethrough to connect with the power supply (not shown) and a monitoring computer (not shown).

In order to prevent heat in the first immovable portion 12 from spreading to the first enclosure 36, a thermally insulating member 17 is located at the bottom of the first immovable portion 12 in the first enclosure 36. The insulating member 17 receives a bottom portion of the first immovable portion 12 therein. The insulating member 17, corresponding to the extension 120 of the first immovable portion 12, defines a concave (not labeled) receiving the extension 120 therein. A bottom of the insulating member 17 and the bottom 362 of the first enclosure 36 defines holes 3622 for allowing the wires of the first heating member (not shown) and the wires of the first temperature sensors 18 of the first immovable portion 12 to extend therethrough to connect with the power supply and the monitoring computer, wherein some holes in the bottom 362 and the bottom of the insulating member 17 are not shown.

A board 19 is positioned over the first movable portion 14. Four columns 190 are secured at corresponding four corners of the first movable portion 14 and extend upwardly to engage in corresponding four through holes (not labeled) defined in four corners of the board 19. The board 19 defines two pairs of spaced orifices 192 corresponding to the through bores 3642 of the ceiling 364 of the first enclosure 36 for extension of the wires of the second heating member 16 and the first temperature sensors 18 therethorugh.

A driving device 40 is fixed on the ceiling 364 of the first enclosure 36. A shaft of the driving device 40 threadedly engages with a bolt 42 which is secured to the board 19 and extends through a hole 3640 defined in the ceiling 364. A space (not labeled) is defined between the board 19 and the ceiling 364 of the first enclosure 36 for movement of the first movable portion 14. When the driving device 40 operates, the shaft rotates, and the bolt 42 with the board 19 and the first movable portion 14 move upwardly or downwardly relative to the first immovable portion 12 in the first enclosure 36. The driving device 40 in this embodiment is a step motor, although it can be easily apprehended by those skilled in the art that the driving device 40 can also be a pneumatic cylinder or a hydraulic cylinder. In use, the driving device 40 accurately drives the first movable portion 14 to move linearly relative to the first immovable portion 12. For example, the first movable portion 14 can be driven to depart a certain distance such as 5 millimeters from the first immovable portion 12 to facilitate the insertion of the evaporating sections of the heat pipes being tested into the heating channels 54, 55 or withdrawn from the heating channels 54, 55 after the heat pipes have been tested. On the other hand, the first movable portion 14 can be driven to move toward the first immovable portion 12 to thereby realize an intimate contact between the evaporating sections of the heat pipes and the first immovable and movable portions 12, 14 during the test. Accordingly, the requirements for testing, i.e. accuracy, ease of use and speed, can be realized by the testing apparatus in accordance with the present invention.

The cooling set 20 comprises a second immovable portion 22 and a second movable portion 24 movably located on the second immovable portion 22.

The second immovable portion 22 is made of metal having good heat conductivity. Cooling passageways (not shown) are defined in an inner portion of the second immovable portion 22, to allow coolant to flow in the second immovable portion 22. An inlet 228 and an outlet 228 extend from a lateral side of the second immovable portion 22 to communicate the passageways with a constant temperature coolant circulating device (not shown); therefore, the passageways, inlet 228, outlet 228 and the coolant circulating device cooperatively define a cooling system for the coolant circulating through the second immovable portion 22 to remove heat from the condensing sections of the heat pipe 80 and the another heat pipe in test. The second immovable portion 22 has a first, second cooling grooves 224, 225 defined in a top face thereof, for receiving the condensing sections of the heat pipes. The first cooling groove 224 is spaced from and parallels to the second cooling groove 225. In this embodiment, the first cooling groove 224 has a semicircular cross section. The second cooling groove 225 has a rectangular cross section. Corresponding to each of the cooling grooves 224, 225, two through holes (not shown) are defined in the second immovable portion 22 and are in communication with a corresponding one of the cooling grooves 224, 225. Each of the through holes has a first temperature sensors 18 inserted thereinto. The first temperature sensors 18 have detecting sections (not labeled) thereof exposed to the corresponding cooling grooves 224, 225. The detecting portions of the first temperature sensors 18 are capable of automatically contacting the condensing sections of the heat pipes in order to detect temperatures of the condensing sections of the heat pipes.

The second movable portion 24 is also made of metal having good heat conductivity. The second movable portion 24, corresponding to the cooling grooves 224, 225 of the second immovable portion 22, has cooling grooves 244, 245 defined therein, whereby a first, second cooling channels 64, 65 are cooperatively defined by the two pairs of cooling grooves 224, 244 and 225, 245, respectively, when the second movable portion 24 moves to reach the second immovable portion 22. Thus, an intimate contact between the condensing sections of the heat pipes and the second movable and immovable portions 24, 22 can be realized, thereby reducing heat resistance between the heat pipes and the second movable and immovable portions 24, 22. Two pairs of first temperature sensors 18 are inserted into through holes (not shown) defined in the second movable portion 24 from a top thereof to reach a position wherein detecting portions (not labeled) of the first temperature sensors 18 are located in the cooling grooves 244, 245 and capable of automatically contacting the condensing sections of the heat pipes to detect the temperature of the condensing sections.

In this embodiment, in order to precisely position the second movable portion 24 relative to the immovable portion 22, the immovable portion 22 has two flanges 226 integrally extending upwardly from two opposite top edges thereof and toward the second movable portion 24. The outer face of each flange 226 is coplanar with the outer face of a main body (not labeled) of the second immovable portion 22. The two flanges 226 function as a positioning structure to position the second movable portion 24 therebetween, which prevents the second movable portion 24 from deviating from the second immovable portion 22 during test of the heat pipes in mass production, thereby ensuring the cooling grooves 224, 244 and 225, 245 of the second immovable and movable portions 22, 24 to always be aligned with each other. When the second movable portion 24 moves to the second immovable portion 22, the channels 64, 65 can be always precisely and easily formed for receiving the condensing sections of the heat pipes for test. Outer faces of the second movable portion 24 slidably contact the two flanges 226 of the second immovable portion 22 when the second movable portion 24 moves relative to the second immovable portion 22. Alternatively, the second movable portion 24 can have two flanges slidably engaging with two opposite sides of the second immovable portion 22 to keep the second immovable portion 22 aligned with the second movable portion 24.

The cooling set 20 is accommodated in a cuboidal second enclosure 38. The second enclosure 38 has a bottom (not labeled) positioned on the supporting set 30 and three interconnecting sidewalls (not labeled) extending upwardly from the bottom. An entrance (not labeled) is defined in an opened side of the second enclosure 38 for disposing, assembling or dismantling the second movable portion 24 and the second immovable portion 22 in the second enclosure 38. A door board 380 is removably attached to the entrance for facilitating the second immovable portion 22 and the second movable portion 24 entering into/exiting out of the second enclosure 38. The bottom and two opposite ones of the sidewalls form a plurality of ribs 386 on inner faces thereof, for reducing contacting area between the cooling set 20 and the second enclosure 38. A slot (not labeled) is defined between two ribs 386 of the bottom for extension of wires of the first temperature sensors 18 to connect with the monitoring computer. Corresponding to the cooling channels 64, 65 between the second immovable portion 22 and the second movable portion 24, a pairs of lengthwise openings 3802 are defined in each of the door board 380 and one of sidewalls of the second enclosure 38 which faces the door board 380, for extension of the condensing sections of heat pipes into the cooling channels 64, 65 via the openings 3802, wherein the openings of the sidewall are not shown. Corresponding to the inlet 228 and outlet 228 of the second immovable portion 22, the door board 380 defines two through bores 3806, allowing the inlet 228 and outlet 228 to extend out of the second enclosure 38. The door board 380 defines two pairs of cutouts 3804 in an upper portion and a lower portion thereof, respectively, for allowing wires of the first temperature sensors 18 extending therethrough to connect with the monitoring computer. A board 29 is secured to a top of the second movable portion 24 in the second enclosure 38. The board 29 defines two pairs of spaced apertures 292 for allowing the wires of the first temperature sensors 18 to extend therethrough. A space (not labeled) is left between the board 29 and a ceiling of the second enclosure 38 for movement of the second movable portion 24. A bolt 42 is fixed to the board 29. The ceiling of the second enclosure 38 defines a through hole 3840 for extension of the bolt 42 to engage with a shaft of a driving device 40. When the driving device 40 operates, the shaft rotates, and the board 29 and the second movable portion 24 move upwardly or downwardly away from or toward the second immovable portion 22 in the second enclosure 38, thereby realizing intimate contact between the condensing sections of the heat pipes and the second movable and immovable portions 24, 22. In this manner, heat resistance between the condensing sections of the heat pipes and the second movable and immovable portions 24, 22 can be minimized.

The supporting set 30 comprises a supporting leg, a supporting platform 34 on the supporting leg, and first, second supporting seats 344 positioned on the supporting platform 34 and respectively supporting the heating set 10, cooling set 20 thereon.

The supporting platform 34 is a rigid member and has a substantially T-shaped configuration. The supporting platform 34 has a top face thereof defining two guiding slots 340 corresponding to the two supporting seats 344. The two guiding slots 340 receive lower portions of the first, second supporting seats 344 therein, respectively. The two guiding slots 340 cooperatively define a T-shaped configuration. The first, second supporting seats 344 can make linear movement along the guiding slots 340. Furthermore, orientations of the first, second supporting seats 344 can be changed by lifting the first and second supporting seats 344 away from the slots 340, turning the first and second supporting seats 344 to the desired orientations and finally re-inserting the first and second supporting seats 344 into the slots 340, respectively. The supporting platform 34 defines a plurality of holes 342 in two lateral sides thereof, communicating with the guiding slots 340. Corresponding to each supporting seat 344, a positioning bolt 343 is received in one of the holes 342 and can engage with the lower portion of the supporting seat 344. The bolt 343 is received in an appropriate one of the holes 342 and secures the supporting seat 344 to be fixedly located at an appropriate position of the supporting platform 34 according to configurations and sizes of the heat pipes in actual tests. Corresponding to the heating set 10, the first supporting seat 344 defines a trough 3442 in a top face thereof for extension of the wires of the first heating member (not shown) and the first temperature sensors 18 from the first enclosure 36 therethrough.

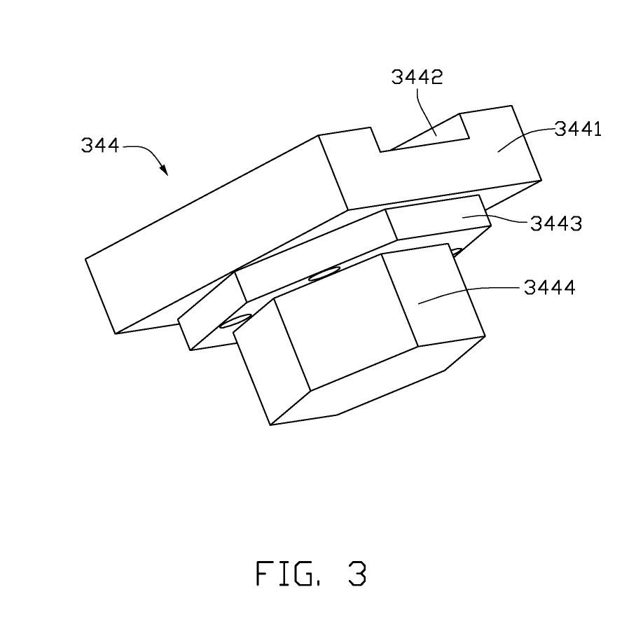

Referring to FIG. 3, the first supporting seat 344 comprises three-stepped portions: a top portion 3441 mounting the heating set 10 thereon, a middle portion 3443 and a lower portion 3444 positioned in the slot 340 of the supporting platform 34. In this embodiment, the top portion 3441 is a substantially rectangular plate and has the trough 3442 defined in a central portion of the top face thereof. At two sides of the trough 3442, the top face of the top portion 3441 defines two pairs of fixing holes 3440 for fixing the heating set 10 to the supporting seat 344. The middle portion 3443 is a flatten prism and has a regularly hexagonal cross section. The middle portion 3443 is located above the top face of the supporting platform 34. The lower portion 3444 is a prism and has a regularly hexagonal cross section. The lower portion 3444 is slidable in the slot 340. A width of two opposite sides of the lower portion 344 is equal to a width of the corresponding slot 340; thus, the orientation of the supporting seat 340 can be adjusted each time for at least 60 degrees.

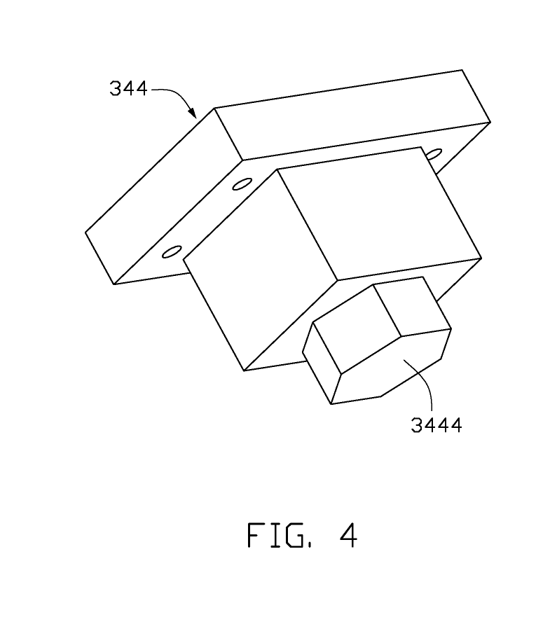

Referring to FIG. 4, the second supporting seat 344 comprises three-stepped portions: a top portion (not labeled) mounting the cooling set 20 thereon, a middle portion (not labeled), and a lower portion 3444 positioned in the slot 340 of the supporting platform 34. In this embodiment, the top portion is a substantially rectangular plate. The middle portion is a prism and has a rectangular cross section. The middle portion is located above the top face of the supporting platform 34. The lower portion 3444 is a prism and has a regularly hexagonal cross section. The lower portion 3444 is slidably received in the slot 340. The lower portion 3444 enables an orientation of the supporting seat 344 to be changed in respect to the corresponding slot 340 for at least 60 degrees during each time of adjustment.

The supporting leg comprises an electromagnetic holding chuck 324 supporting an end of the supporting platform 34, and two adjustable feet 322 supporting other two ends of the supporting platform 34. The electromagnet holding chuck 324 is made from ferroalloy. The testing apparatus can be easily fixed at any desired position by using the holding chuck 324 or adjusting the feet 322.

In use, an example according to the first embodiment of the present invention, performance of the curved heat pipe 80 is tested. The heat pipe 80 has an evaporating section at an end thereof and a condensing section at an opposite end thereof. A 120-degree angle is defined between the evaporating section and the condensing section. The evaporating section of the heat pipe 80 has a circular cross section. The condensing section of the heat pipe 80 has a circular cross section. The supporting set 30 is adjusted, wherein the first, second supporting seats 344 are adjusted to define a 120-degree angle between the heating channel 54 of the heating set 10 and the cooling channel 64 of the cooling set 20. The evaporating section of the heat pipe 80 extends through the opening of the sidewall of the first enclosure 36 and is received in the heating channel 54 of the heating set 10. The condensing section of the heat pipe 80 extends through an elliptic one of the openings 3802 of the door board 380 of the second enclosure 38 and is received in the cooling channel 64 of the cooling set 20. The driving devices 40 drive the first, second movable portions 14, 24 to move relative to the first, second immovable portion 12, 22 to allow the evaporating section and the condensing section in intimately contact with corresponding heating set 10 and cooling set 20. The power supply energizes the heating members 16 of the heating set 10, and the evaporating section is heated. The coolant circulates in the cooling set 20, and the condensing section is cooled. The first temperature sensors 18 and the second temperature sensor work and detect temperature of the evaporating section and condensing section of the heat pipe 80. Therefore, performance of the heat pipe 80 can be obtained from the monitoring computer. Understandably, meanwhile, the another heat pipe can be tested in the channels 55, 65 during the test of the heat pipe 80.

In this embodiment, due to the lower portions 3444 of the first, second supporting seats 344 being regularly hexagonal prisms, the first, second supporting seats 344 can rotate n*60 degrees (n=0, 1, 2, 3, . . . ) relative to each other, so that angles of n*60 degrees (n=0, 1, 2, 3, . . . ) can be defined between the heating channels 54, 55 of the heating set 10 and the cooling channels 64, 65 of the cooling set 20; therefore, bent heat pipes with n*60 degrees (n=1, 2, 3, . . . ) between the evaporating sections and the condensing sections thereof can be tested in the performance testing apparatus.

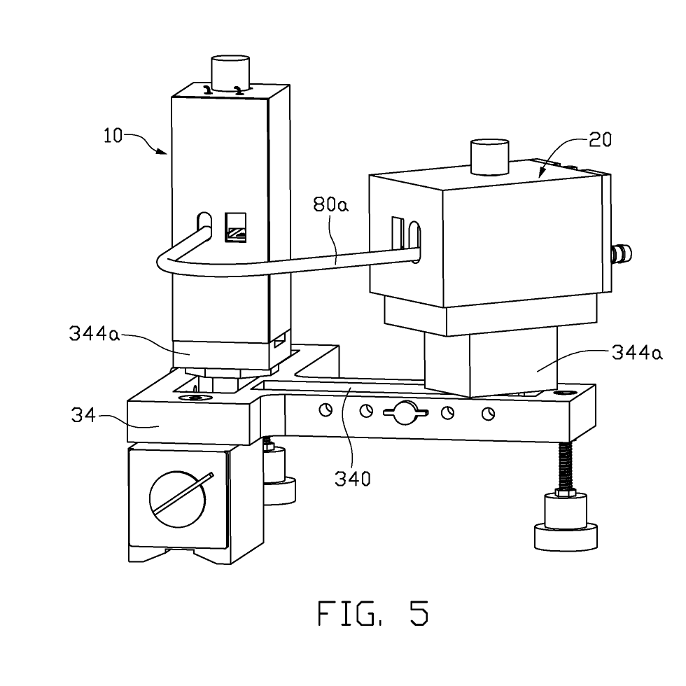

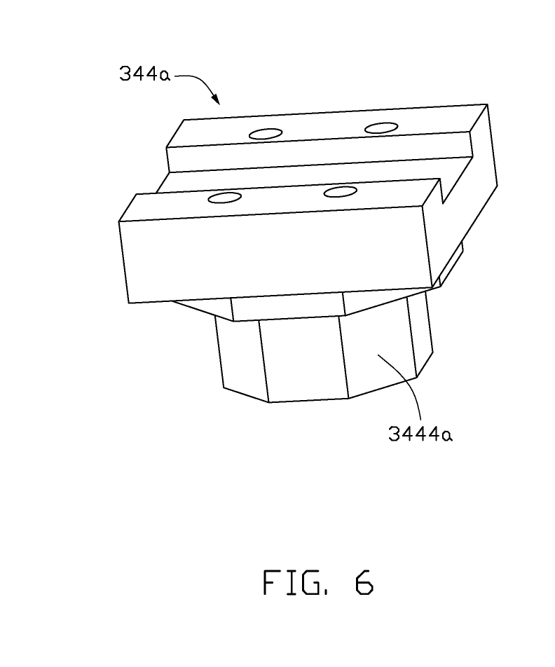

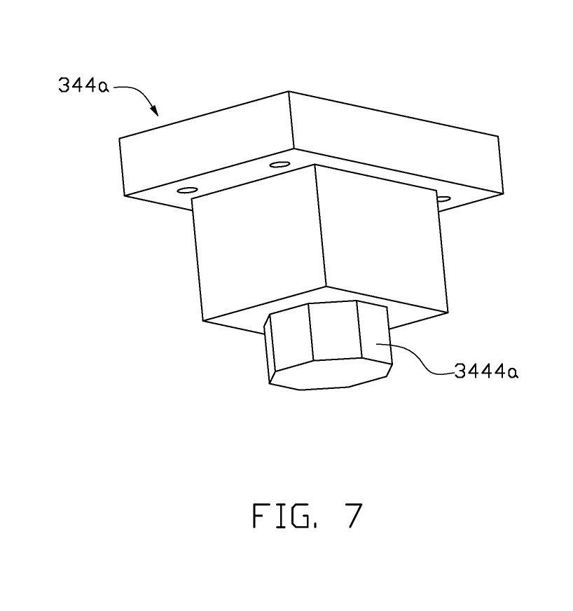

Referring to FIGS. 5-7, a performance testing apparatus for heat pipes in accordance with a second embodiment of the present invention is shown. The apparatus for heat pipes in this embodiment has a configuration similar to that of the first embodiment; a difference therebetween is that lower portions 3444a of first, second supporting seats 344a which mount the heating, cooling sets 10, 20 thereon, are regularly octangle prisms. In this embodiment, due to the lower portions 3444a of the first, second supporting seats 344a being regularly eight-angular prisms, the first, second supporting seats 344 can rotate n*45 degrees (n=1, 2, 3, . . . ) relative to each other, so that angles with n*45 degrees (n=0, 1, 2, 3, . . . ) can be defined between the heating channels 54, 55 of the heating set 10 and the cooling channels 64, 65 of the cooling set 20; therefore, bent heat pipes with n*45 degrees (n=0, 1, 2, 3, . . . ) between the evaporating sections and the condensing sections thereof can be tested in the performance testing apparatus. An example of this embodiment, a heat pipe 80a is tested, wherein an angle of 45 degrees is defined between an evaporating section (not labeled) and a condensing section (not labeled) of the heat pipe 80a.

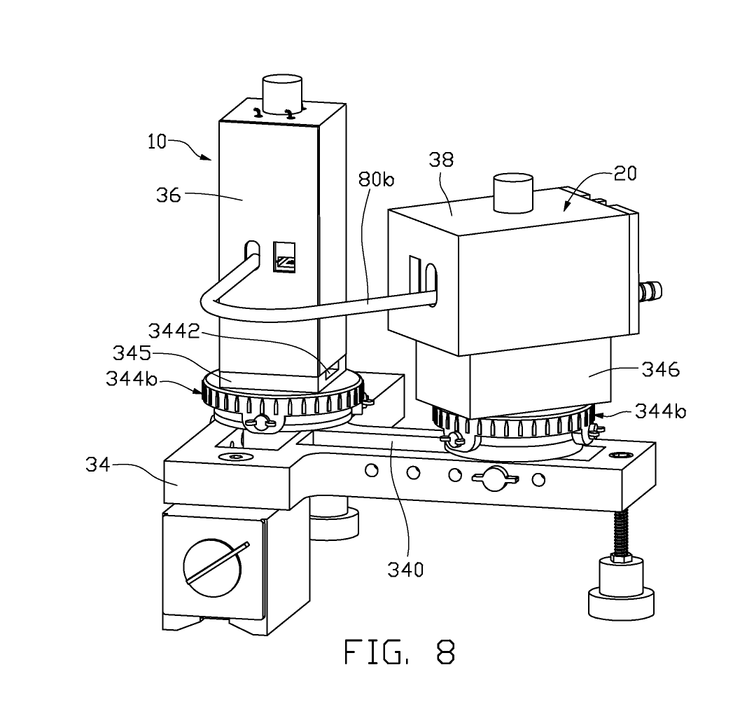

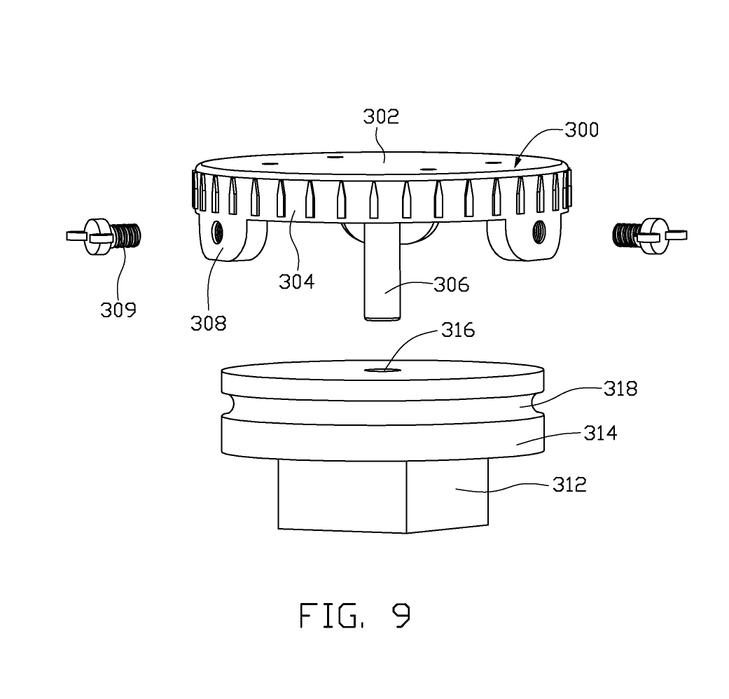

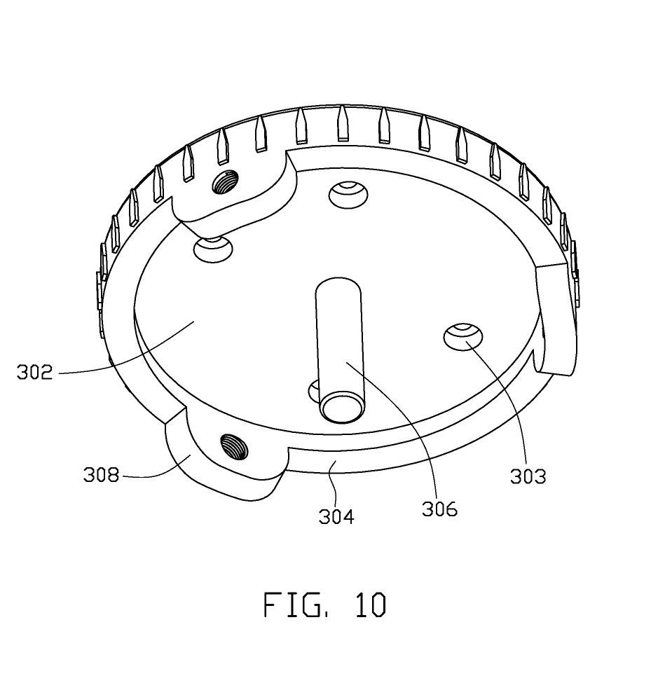

Referring to FIGS. 8-10, a performance testing apparatus for heat pipes in accordance with a third embodiment of the present invention is shown. The apparatus in this embodiment has a construction similar to that of the first embodiment, but has two supporting seats 344b different from the first, second supporting seats 344 of the apparatus of the first embodiment. The supporting seat 344b in this embodiment comprises a lower portion 312 slidably received in the slot 340 of the supporting platform 34, a middle portion 314 integrally extending from the lower portion 312, and a top portion 300 rotatably engaging with the middle portion 314. The lower portion 312 is a cubical body. The middle portion 314 is a cylindrical disc located above the supporting platform 34. The middle portion 314 defines a circumferentially positioning trough 318 in a circumferential periphery thereof. The middle portion 314 defines an engaging hole 316 in a center of a top face thereof. The top portion 300 is a turnable disc, and comprises a discal ceiling 302 and a ring wall 304 extending downwardly from a circumferential edge of the ceiling 302. An engaging column 306 extends downwardly from a center of a bottom face of the ceiling 302 to rotatably engage in the hole 316 of the middle portion 314. Three spaced fixing ears 308 evenly extend downwardly from a bottom of the ring wall 304 to a position corresponding to the trough 318 of the middle portion 314. Each ear 308 defines a thread hole (not labeled) for extension of an operating screw 309 to engage in the trough 318. On a circumferential periphery of the ring wall 304, a scale (not labeled) is formed thereon. In this embodiment, a first, second blocks 345, 346 are positioned on a top face of the ceilings 302 of the supporting seats 344b and mount the heating set 10 and the cooling set 20 thereon, respectively. The trough 3442 is defined in the first block 345 for extension of wires from the first enclosure 36. In this embodiment, due to the top portions 300 being able to rotate any degrees relative to the middle portions 314 of the supporting seats 344b, the heating set 10 on one of the supporting seats 344b can rotate any degrees relative to the cooling set 20 on the other of the supporting seats 344b, so that angles with any degrees can be defined between the heating channels 54, 55 of the heating set 10 and the cooling channels 64, 65 of the cooling set 20; therefore, bent heat pipes with angles of any degrees between evaporating sections and condensing sections thereof can be tested in the performance testing apparatus. During adjusting angles between the heating channels 54, 55 of the heating set 10 and the cooling channels 64, 65 of the cooling set 20 to meet the angles between the evaporating sections and the condensing sections, the screws 309 in the ears 308 are firstly loosened to a first position. At this time, one or both of the top portions 300 are rotated relative to corresponding middle portions 314 to desired angles, which can be read from the scales on the ring walls 304. After reaching the desired angle, the screws 309 in the ears 308 are tighten to a second position, in which the screws 309 extend into the troughs 318 of the middle portions 314 and fixedly engage with the middle portions 314; thus, the top portions 300 are fixed relative to the middle portions 314. In use of the performance testing apparatus of this embodiment, a bent heat pipe 80b with an angle of any degree defined between an evaporating section and a condensing section thereof can be tested.

Additionally, in the present invention, in order to lower cost of or simplify manufacture of the testing apparatus, the insolating member 17, the boards 19, 29, the socket 182, the supporting platform 34, the first enclosure 36 and the second enclosure 38 can be made from low-cost material such as PE (Polyethylene), ABS (Acrylonitrile Butadiene Styrene), PF (Phenol-Formaldehyde), PTFE (Polytetrafluoroethylene) and so on. The first, second immovable portions 12, 22, the first, second movable portions 14, 24 can be made from copper (Cu) or aluminum (Al). The first, second immovable portions 12, 22, the first, second movable portions 14, 24 can have silver (Ag) or nickel (Ni) plated on inner faces defining the channels 54, 55, 64, 65 to prevent the oxidization of the inner face.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A performance testing apparatus for heat pipes comprising:
a heating set for heating an evaporating section of a heat pipe, the heating set comprising a first immovable portion, a first movable portion being movable relative to the first immovable portion, a channel being defined between the first immovable portion and the first movable portion for receiving the evaporating section of the heat pipe, a temperature sensor being exposed to the heating channel for detecting temperature of the evaporating section of the heat pipe, and a heating member being attached to at least one of the first movable portion and the immovable portion;
a cooling set for cooling a condensing section of the heat pipe, the cooling set comprising a second immovable portion, a second movable portion being movable relative to the second immovable portion, a cooling channel being defined between the second immovable portion and the second movable portion for receiving the condensing section of the heat pipe, a temperature sensor being exposed to the cooling channel for detecting temperature of the condensing section of the heat pipe, and a cooling passageway being formed in one of the second immovable portion and the movable portion; and
a supporting set adjustably supporting the heating set and the cooling set thereon, the supporting set comprising a first supporting seat supporting the heating set thereon and a second supporting seat supporting the cooling set thereon, the first supporting seat being ratable relative to the second supporting seat to rotate the heating set relative to the cooling set to a desired orientation.

2. The testing apparatus of claim 1, wherein the supporting set comprises a supporting platform mounting the first supporting seat and the second supporting seat thereon.

3. The testing apparatus of claim 2, wherein the first supporting seat comprises a first portion engaging with the supporting platform, a third portion supporting the heating set thereon, and a middle portion located between and engaging with the first portion and the third portion.

4. The testing apparatus of claim 3, wherein an orientation of the first portion of the first supporting seat is adjustable relative to the supporting platform.

5. The testing apparatus of claim 3, wherein the first supporting seat is linearly movable relative to the first supporting seat.

6. The testing apparatus of claim 4, wherein the supporting platform defines a slot in a top face thereof, and the first portion of the first supporting seat is received in the slot.

7. The testing apparatus of claim 6, wherein the first portion of the first supporting seat is a prism.

8. The testing apparatus of claim 7, wherein the first portion of the first supporting seat is a regularly hexagonal prism.

9. The testing apparatus of claim 7, wherein the first portion of the first supporting seat is a regularly octangle prism.

10. The testing apparatus of claim 3, wherein the third portion of the first supporting seat is rotatable relative to the supporting platform.

11. The testing apparatus of claim 10, wherein the third portion of the first supporting seat is rotatably engaged with the second portion.

12. The testing apparatus of claim 11, wherein the second portion of the first supporting seat is a cylindrical disc and defines a circumferential trough in a circumferential periphery, and the third portion of the first supporting extends a plurality of engaging ears corresponding to the trough of the second portion.

13. The testing apparatus of claim 12, wherein each of the ears of the third portion defines a thread hole in which an operating screw extends, the operating screw in the ear is movable between first and second positions, at the first position where the operating screw is loosened from the second portion and the third portion can rotate relative to the second portion, and at the second position where the operating screw is located in the trough of the second portion and fixedly engages with the second portion and the third portion is fixedly relative to the second portion.

14. The testing apparatus of claim 12, wherein the third portion of the first supporting seat comprises a ceiling and a ring wall extending from a circumferential edge of the ceiling, the ring wall having a scale thereon, the ceiling extending an engaging column rotatably engaged in an engaging hole defined in the second portion of the first supporting seat.

15. The testing apparatus of claim 3, wherein the second supporting seat comprises a first portion engaging with the supporting platform, a third portion supporting the cooling set thereon, and a middle portion located between the first portion and the third portion.

16. The testing apparatus of claim 15, wherein the first portion of the second supporting seat is slidably engaged in a slot defined in the supporting platform.

17. The testing apparatus of claim 15, wherein the third portion of the second supporting seat is rotatably engaged with the second portion.
